(19) United States
(12) Patent Application Publication
(10) Pub. No.: US 2012/0124454 A1
(43) Pub. Date: May 17, 2012

(54) Systems and Methods for ADC Sample Based Timing Recovery

(75) Inventors: Jingfeng Liu, Longmont, CO (US); Hongwei Song, Longmont, CO (US); Haotian Zhang, Longmont, CO (US)

(73) Assignee: LSI Corporation

(21) Appl. No.: 12/947,962

(22) Filed: Nov. 17, 2010

(51) Int. Cl. G06F 11/07

(52) U.S. Cl. 714/799; 714/E11.024

(57) ABSTRACT

Various embodiments of the present invention provide systems and methods for data processing. For example, a data processing circuit is discussed that includes an analog to digital converter circuit operable to receive a data input and to provide corresponding digital samples, and a digital filter circuit operable to receive the digital samples and to provide a filtered output. A data detector circuit is operable to perform a data detection process on the filtered output to yield a detected output, and a phase detector circuit operable to calculate an error feedback value based at least in part on the detected output and the digital samples.

### BACKGROUND OF THE INVENTION

The present inventions are related to systems and methods for data processing, and more particularly to systems and methods for loop processing.

Various data processing circuits have been developed that include one or more loops. For example, a data processing circuit may receive a data signal that repeats at a defined frequency. In some cases, such loops are adjusting multiple modifiable parameters together. This can result in loop oscillation and/or improper loop operation.

Hence, for at least the aforementioned reasons, there exists a need in the art for advanced systems and methods for data processing.

BRIEF SUMMARY OF THE INVENTION

The present inventions are related to systems and methods for data processing, and more particularly to systems and methods for loop processing.

Various embodiments of the present invention provide data processing circuits that include an analog to digital converter circuit operable to receive a data input and to provide corresponding digital samples, and a digital filter circuit operable to receive the digital samples and to provide a filtered output. A data detector circuit is operable to perform a data detection process on the filtered output to yield a detected output, and a phase detector circuit operable to calculate an error feedback value based at least in part on the detected output and the digital samples. In some cases, a sampling of the data input by the analog to digital converter circuit is governed at least in part by a sampling clock derived from the error feedback value.

In some instances of the aforementioned embodiments, the phase detector circuit includes a first multiplier circuit, a second multiplier circuit and a summation circuit. The first multiplier circuit is connected to the digital samples and a first derivative of the detected output, and is operable to multiply the digital samples by the first derivative of the detected output to yield a first product. The second multiplier circuit is connected to a delayed version of the digital samples and a second derivative of the detected output, and is operable to multiply delayed version of the digital samples by the second derivative of the detected output to yield a second product. The summation circuit is operable to subtract the second product from the first product to yield the error feedback value.

In some instances of the aforementioned embodiments, the data processing circuit further includes a convolution circuit operable to convolve the detected output with a target to yield a target output. In such instances, the second derivative of the detected output is the target output, and the first derivative of the detected output is a delayed version of the target output. In some cases, the detected output includes hard decision data.

In other instances of the aforementioned embodiments, the data processing circuit further includes a soft decision conversion circuit operable to convert the detected output into a hard output, and a convolution circuit operable to convolve the hard output with a target to yield a target output. In such instances, the second derivative of the detected output is the target output, and the first derivative of the detected output is a delayed version of the target output. In some cases, the detected output includes soft decision data, and the hard output is a mean of the soft decision data.

Other embodiments of the present invention provide methods for timing recovery in a data processing circuit. Such methods include: receiving a data input, converting the data input into digital samples synchronous to a sampling clock, filtering the digital samples to yield a filtered output, performing a data detection on the filtered output to yield a detected output, multiplying the digital samples by a first derivative of the detected output to yield a first product, multiplying a delayed version of the digital samples by a second derivative of the detected output to yield a second product, subtracting the second product from the first product to yield an error feedback value, and adjusting the sampling clock based at least in part on the error feedback value. In some instances, the methods further include convolving the detected output with a target to yield a target output. In such instances, the first derivative of the detected output is a delayed version of the target output, and the second derivative of the detected output is the target output. In other instances of the aforementioned embodiments, the methods further include converting a soft decision portion of the detected output into a hard output, and convolving the hard output with a target to yield a target output. In such instances, the first derivative of the detected output is a delayed version of the target output, and the second derivative of the detected output is the target output.

This summary provides only a general outline of some embodiments of the invention. Many other objects, features, advantages and other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 depicts an existing timing recovery loop circuit;

FIG. 2 depicts a timing recovery loop circuit in accordance with various embodiments of the present invention;

FIG. 3 depicts another timing recovery loop circuit in accordance with other embodiments of the present invention;

FIG. 4 is a flow diagram showing a method for ADC sample based timing recovery in accordance with various embodiments of the present invention;

FIG. 5 shows a storage system including a read channel circuit with an ADC sample based timing recovery circuit in accordance with some embodiments of the present invention; and

FIG. 6 depicts a wireless communication system including an ADC sample based timing recovery circuit in accordance with some embodiments of the present invention.

### DETAILED DESCRIPTION OF THE INVENTION

The present inventions are related to systems and methods for data processing, and more particularly to systems and methods for loop processing.

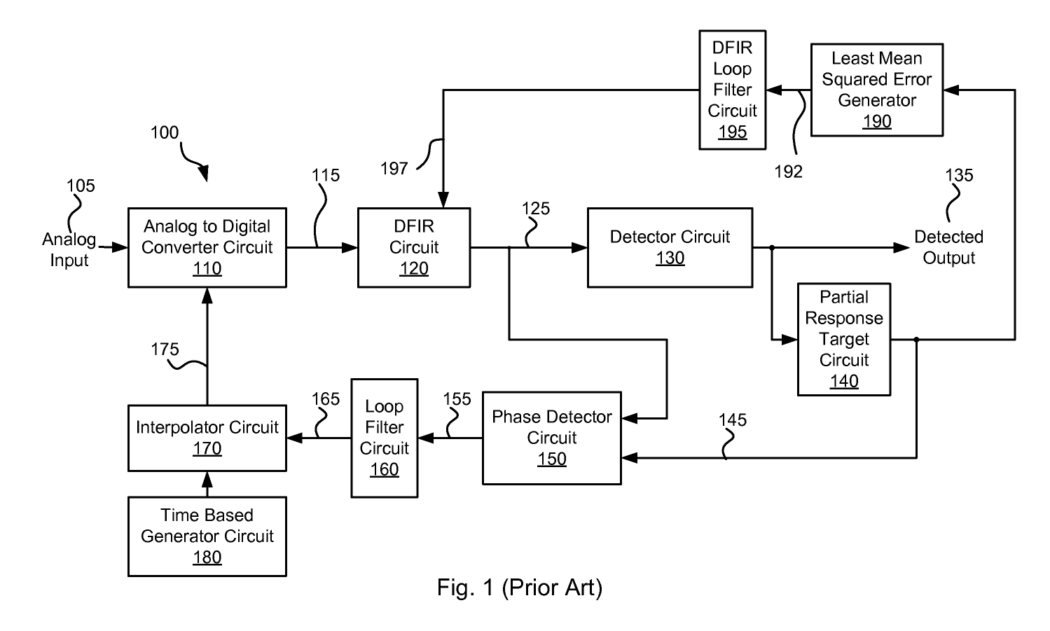

Turning to FIG. 1, an existing timing recovery loop circuit 100 is depicted. Timing recovery loop circuit 100 includes an analog to digital converter circuit 110 that converts an analog input signal 105 into a series of digital samples 115 that are provided to a digital finite impulse response (DFIR) filter 120. DFIR filter 120 filters the received input and provides a corresponding filtered output 125 to both a detector circuit 130 and a phase detector circuit 150. Detector circuit 130 performs a data detection process on the received input resulting in a detected output 135. In performing the detection process, detector circuit 130 attempts to correct any errors in the received data input.

Detected output 135 is provided to a partial response target circuit 140 that creates a partial response output 145 compatible with filtered output 125. Detected output 135 is also provided to a least mean squared error generator circuit 190 that provides an error output 192 to a loop filter circuit 195. It should be noted that the least mean squared error generator circuit is one type of error generator circuit that may be used in relation to different embodiments of the present invention. Based upon the disclosure provided herein, one of ordinary skill in the art will recognize other types of error generator circuits that may be used in relation to different embodiments of the present invention. For example, a zero forcing error generator circuit or a hybrid zero forcing error generator circuit and least mean squared error generator circuit may be used in place of least mean squared error generator circuit 190. DFIR loop filter circuit 195 provides a filtered output 197 (i.e., filter taps) to DFIR circuit 120. The operation of DFIR circuit 120 is governed at least in part by filtered output 197.

Phase detector circuit 150 determines a phase difference between partial response output 145 and filtered output 125 and yields a phase error output 155. When timing recovery loop circuit 100 is properly synchronized to analog input 105, phase error output 155 goes to zero. Phase error output 155 is provided to a loop filter circuit 160 that filters the received input and provides a corresponding filtered output 165. Filtered output 165 is provided to an interpolator circuit 170 that is operable to determine an optimal sampling phase/frequency for a sampling clock 175. Sampling clock 175 is based on a clock input provided by a time based generator circuit 180. The next instance of analog input 105 is sampled by analog to digital converter circuit 110 synchronous to sampling clock 175.

As shown, timing recovery loop circuit 100 uses filtered output 125 to generate both filtered output 197 provided to DFIR circuit 120 and sampling clock 175. As filtered output 197 effects sampling clock 175 and sampling clock 175 effects filtered output 197, there is a possibility that the loops will be unstable. To limit the instability, filtered output 197 may be constrained. Further, the interaction can cause a change in the transfer function of DFIR circuit 120 resulting in sub-optimal operation of DFIR circuit 120.

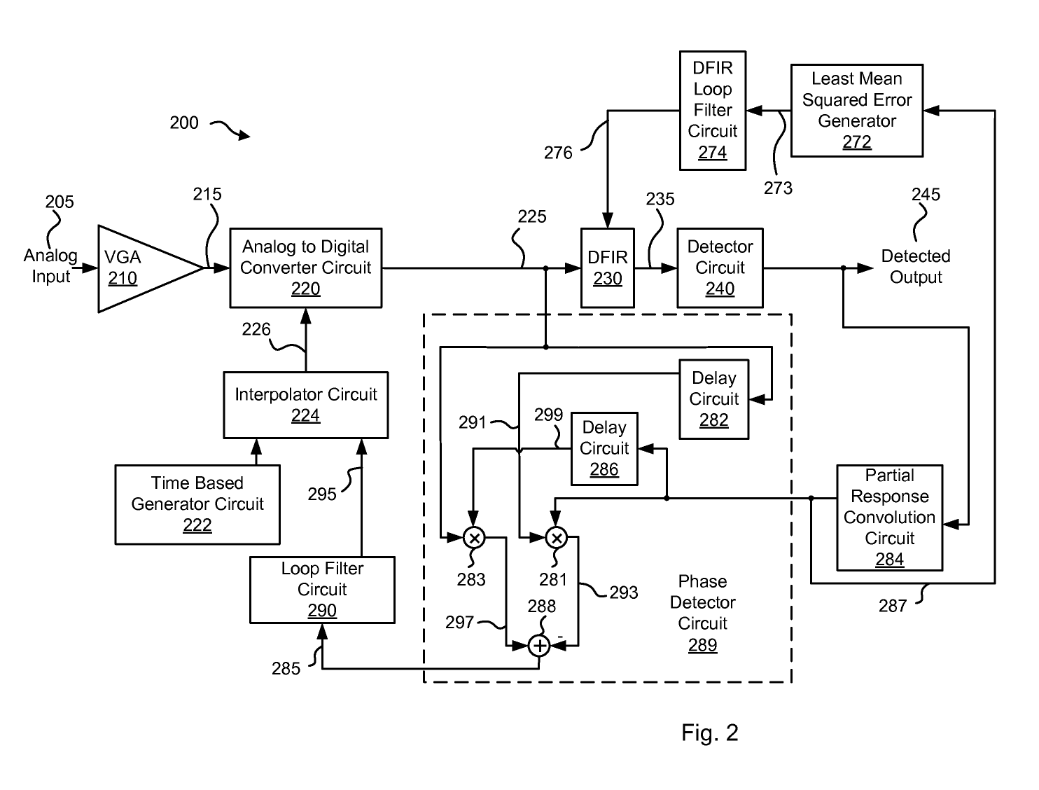

Turning to FIG. 2 a timing recovery loop circuit 200 is shown in accordance with various embodiments of the present invention. Timing recovery loop circuit 200 includes a variable gain amplifier 210 that receives an analog input 205. Variable gain amplifier 210 may be any circuit known in the art that is capable of amplifying a received signal by a gain that can be changed. Based upon the disclosure provided herein, one of ordinary skill in the art will recognize a variety of circuits that may be used to implement variable gain amplifier 210. In some embodiments of the present invention, variable gain amplifier 210 can be replaced by a fixed gain amplifier as are known in the art, and/or may be eliminated altogether in which case analog input 205 is provided directly to an analog to digital converter circuit 220. Analog input 205 may be any analog signal carrying information to be processed. In some embodiments of the present invention, analog input 205 is derived from a storage medium. In other embodiments of the present invention, analog input 205 is derived from a transmission device. Based upon the disclosure provided herein, one of ordinary skill in the art will recognize a variety of analog signals and/or sources thereof that may be used in relation to different embodiments of the present invention. Variable gain amplifier 210 amplifies analog input 205 to yield an amplified output 215 that is provided to analog to digital converter circuit 220.

Analog to digital converter circuit 220 may be any circuit known in the art that is capable of converting an analog signal into a series of digital values representing the received analog signal. Analog to digital converter circuit 220 converts the received amplified output 215 into a series of digital samples 225 that are provided to a DFIR (“digital finite impulse response”) circuit 230. DFIR circuit 230 may be any circuit known in the art for filtering a digital signal. DFIR circuit 230 filters the received digital samples 225 and provides a corresponding filtered output 235 to a detector circuit 240. Detector circuit 240 may be any detector circuit known in the art including, but not limited to, a Viterbi algorithm detector circuit or a maximum a posteriori detector circuit. Based upon the disclosure provided herein, one of ordinary skill in the art will recognize a variety of detector circuits that may be used in relation to different embodiments of the present invention. Detector circuit 240 performs a data detection process on the received input resulting in a detected output 245. Detected output 245 may be provided to a downstream processor (not shown) that performs additional processing on the output.

In addition, detected output 245 is provided to a partial response convolution circuit 284 that creates a partial response output 287. Of note, the portion of detected output 245 that is provided to partial response convolution circuit 284 includes the hard decision data portion and excludes the soft decision portion of detected output 245. Partial response output 287 is provided to a least mean squared error generator circuit 272 that provides an error output 273 to a DFIR loop filter circuit 274. It should be noted that least mean squared error generator circuit 272 is one type of error generator circuit that may be used in relation to different embodiments of the present invention. Based upon the disclosure provided herein, one of ordinary skill in the art will recognize other types of error generator circuits that may be used in relation to different embodiments of the present invention. For example, a zero forcing error generator circuit or a hybrid zero forcing error generator circuit and least mean squared error generator circuit may be used in place of least mean squared error generator circuit 272. DFIR loop filter circuit 274 provides a filtered output 276 (i.e., filter taps) to DFIR circuit 230. The operation of DFIR circuit 230 is governed at least in part by filtered output 276.

In addition, digital samples 225 are provided to a phase detector circuit 289. Phase detector circuit 289 includes a delay circuit 282, a delay circuit 286, a multiplier circuit 281, a multiplier circuit 283, and a summation circuit 288. Digital samples 225 are provided to delay circuit 282 which delays the samples to yield a delayed sample output 291. Partial response output 287 is provided to multiplier circuit 281 that multiplies partial response output 287 by delayed sample output 291 to yield a product 293. In addition, partial response output 287 is provided to delay circuit 286 which delays the output to yield a delayed output 299. Delayed output 299 is provided to multiplier circuit 283 that multiplies delayed output 299 by digital samples 225 to yield a product 297. Product 293 is subtracted from product 297 by summation circuit 288 to yield an error feedback 285.

Error feedback 285 is provided to a loop filter circuit 290 where it is filtered and provided as a filtered output 295. Filtered output 295 is provided to an interpolator circuit 224. Interpolator circuit 224 is operable to determine an optimal sampling phase/frequency for a sampling clock 226. Interpolator circuit 224 may be any circuit known in the art that is capable of identifying a point between two samples that is appropriate for sampling future samples. Sampling clock 226 is based on a clock input provided by a time based generator circuit 222. The next instance of amplified output 215 is sampled by analog to digital converter circuit 220 synchronous to sampling clock 226.

In operation, analog input signal 205 is received. In some cases, the analog input signal is derived from a storage medium. In other cases, the analog input signal is derived from a transmission medium. Based upon the disclosure provided herein, one of ordinary skill in the art will recognize other sources from which the analog input signal may be derived. Analog input 205 is provided to a variable gain amplifier circuit 210 where it is amplified to yield amplified output 215. Amplified output 215 is converted to a series of digital samples 225 synchronous to sample clock 226.

DFIR circuit 230 applies digital filtering to digital samples 225 to yield filtered output 235. Filtered output 235 is provided to detector circuit 240 that performs a data detection process on the received input and provides detected output 245. Partial response convolution circuit 284 convolves detected output 245 with a target to yield partial response output 287. A least mean squared error output 273 is generated using partial response output 287 by least mean squared error generator circuit 272, and error output 273 is filtered by DFIR loop filter circuit 274 to yield filtered output 276 to DFIR circuit 230. Processing from digital samples 225 through DFIR circuit 230, detector circuit 240, partial response convolution circuit 284, least mean squared error generator circuit 272 and DFIR loop filter circuit 274 yielding filtered output 276 is a DFIR adaptation loop.

In addition, phase detector circuit 289 calculates an error feedback 285 by multiplying combinations of digital samples 225, a delayed version of digital samples 225 (i.e., delayed sample output 291), partial response output 287, and a delayed version of partial response output (i.e., delayed output 299). The calculated error is filtered by loop filter circuit 290, and interpolated by interpolator circuit 224 to yield sampling clock 226.

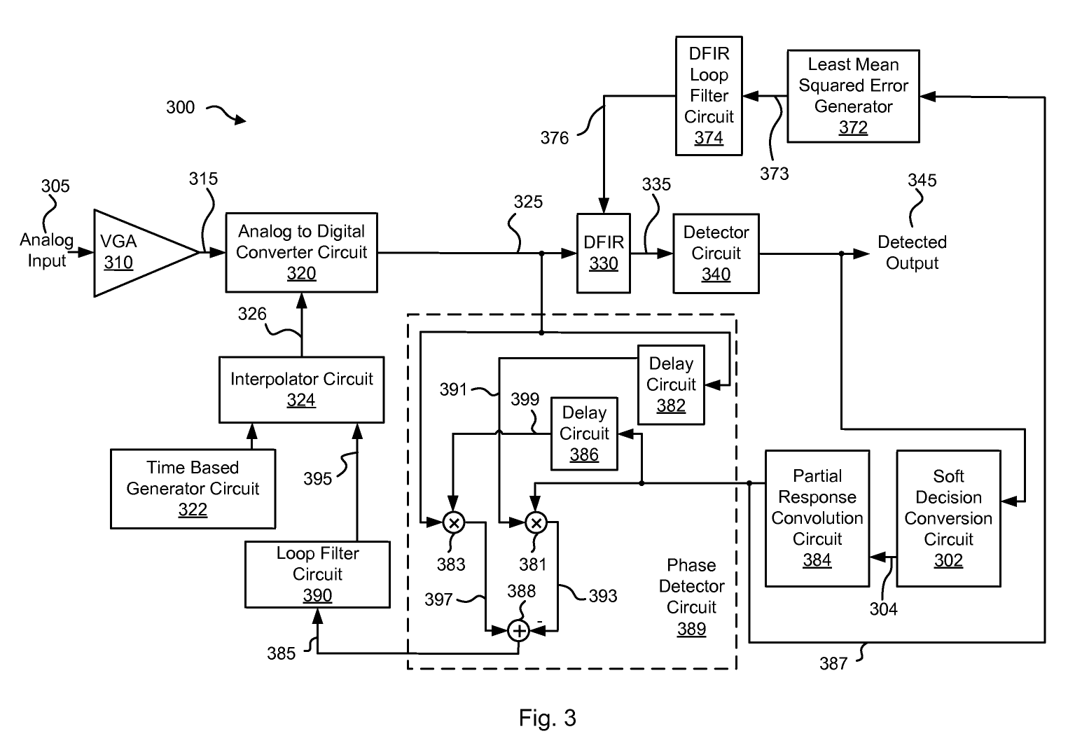

Turning to FIG. 3 a timing recovery loop circuit 300 is shown in accordance with one or more embodiments of the present invention. Timing recovery loop circuit 300 includes a variable gain amplifier 310 that receives an analog input 305. Variable gain amplifier 310 may be any circuit known in the art that is capable of amplifying a received signal by a gain that can be changed. Based upon the disclosure provided herein, one of ordinary skill in the art will recognize a variety of circuits that may be used to implement variable gain amplifier 310. In some embodiments of the present invention, variable gain amplifier 310 can be replaced by a fixed gain amplifier as are known in the art, and/or may be eliminated altogether in which case analog input 305 is provided directly to an analog to digital converter circuit 320. Analog input 305 may be any analog signal carrying information to be processed. In some embodiments of the present invention, analog input 305 is derived from a storage medium. In other embodiments of the present invention, analog input 305 is derived from a transmission device. Based upon the disclosure provided herein, one of ordinary skill in the art will recognize a variety of analog signals and/or sources thereof that may be used in relation to different embodiments of the present invention. Variable gain amplifier 310 amplifies analog input 305 to yield an amplified output 315 that is provided to analog to digital converter circuit 320.

Analog to digital converter circuit 320 may be any circuit known in the art that is capable of converting an analog signal into a series of digital values representing the received analog signal. Analog to digital converter circuit 320 converts the received amplified output 315 into a series of digital samples 325 that are provided to a DFIR (“digital finite impulse response”) circuit 330. DFIR circuit 330 may be any circuit known in the art for filtering a digital signal. DFIR circuit 330 filters the received digital samples 325 and provides a corresponding filtered output 335 to a detector circuit 340. Detector circuit 340 may be any detector circuit known in the art including, but not limited to, a Viterbi algorithm detector circuit or a maximum a posteriori detector circuit. Based upon the disclosure provided herein, one of ordinary skill in the art will recognize a variety of detector circuits that may be used in relation to different embodiments of the present invention. Detector circuit 340 performs a data detection process on the received input resulting in a detected output 345. Detected output 345 may be provided to a downstream processor (not shown) that performs additional processing on the output.

In addition, detected output 345 is provided to a soft decision conversion circuit 302 that converts a soft decision portion of detected output 345 to yield a converted output 304. Converted output 304 may be calculated as a mean value of the soft decision portion of detected output in accordance with the following equation:

$$Converted Output 304 = \frac{exp [ Soft Decision Portion of Detected Output 345 ] - 1}{exp [ Soft Decision Portion of Detected Output 345 ] + 1} .$$

In some cases, the aforementioned conversion is performed using a lookup table that is pre-programmed with values in accordance with the preceding equation. Converted output 304 is provided to a partial response convolution circuit 384 that creates a partial response output 387.

Partial response output 387 is provided to a least mean squared error generator circuit 372 that provides an error output 373 to a DFIR loop filter circuit 374. It should be noted that least mean squared error generator circuit 372 is one type of error generator circuit that may be used in relation to different embodiments of the present invention. Based upon the disclosure provided herein, one of ordinary skill in the art will recognize other types of error generator circuits that may be used in relation to different embodiments of the present invention. For example, a zero forcing error generator circuit or a hybrid zero forcing error generator circuit and least mean squared error generator circuit may be used in place of least mean squared error generator circuit 372. DFIR loop filter circuit 374 provides a filtered output 376 (i.e., filter taps) to DFIR circuit 330. The operation of DFIR circuit 330 is governed at least in part by filtered output 376.

In addition, digital samples 325 are provided to a phase detector circuit 389. Phase detector circuit 389 includes a delay circuit 382, a delay circuit 386, a multiplier circuit 381, a multiplier circuit 383, and a summation circuit 388. Digital samples 325 are provided to delay circuit 382 which delays the samples to yield a delayed sample output 391. Partial response output 387 is provided to multiplier circuit 381 that multiplies partial response output 387 by delayed sample output 391 to yield a product 393. In addition, partial response output 387 is provided to delay circuit 386 which delays the output to yield a delayed output 399. Delayed output 399 is provided to multiplier circuit 383 that multiplies delayed output 399 by digital samples 325 to yield a product 397. Product 393 is subtracted from product 397 by summation circuit 388 to yield an error feedback 385.

Error feedback 385 is provided to a loop filter circuit 390 where it is filtered and provided as a filtered output 395. Filtered output 395 is provided to an interpolator circuit 324. Interpolator circuit 324 is operable to determine an optimal sampling phase/frequency for a sampling clock 326. Interpolator circuit 324 may be any circuit known in the art that is capable of identifying a point between two samples that is appropriate for sampling future samples. Sampling clock 326 is based on a clock input provided by a time based generator circuit 322. The next instance of amplified output 315 is sampled by analog to digital converter circuit 320 synchronous to sampling clock 326.

In operation, analog input signal 305 is received. In some cases, the analog input signal is derived from a storage medium. In other cases, the analog input signal is derived from a transmission medium. Based upon the disclosure provided herein, one of ordinary skill in the art will recognize other sources from which the analog input signal may be derived. Analog input 305 is provided to a variable gain amplifier circuit 310 where it is amplified to yield amplified output 315. Amplified output 315 is converted to a series of digital samples 325 synchronous to sample clock 326.

DFIR circuit 330 applies digital filtering to digital samples 325 to yield filtered output 335. Filtered output 335 is provided to detector circuit 340 that performs a data detection process on the received input and provides detected output 345. Partial response convolution circuit 284 convolves detected output 345 with a target to yield partial response output 387. A least mean squared error output 373 is generated using partial response output 387 by least mean squared error generator circuit 372, and error output 373 is filtered by DFIR loop filter circuit 374 to yield filtered output 376 to DFIR circuit 330. Processing from digital samples 325 through DFIR circuit 330, detector circuit 340, partial response convolution circuit 384, least mean squared error generator circuit 372 and DFIR loop filter circuit 374 yielding filtered output 376 is a DFIR adaptation loop.

In addition, phase detector circuit 389 calculates an error feedback 385 by multiplying combinations of digital samples 325, a delayed version of digital samples 325 (i.e., delayed sample output 391), partial response output 387, and a delayed version of partial response output (i.e., delayed output 399). The calculated error is filtered by loop filter circuit 390, and interpolated by interpolator circuit 324 to yield sampling clock 326.

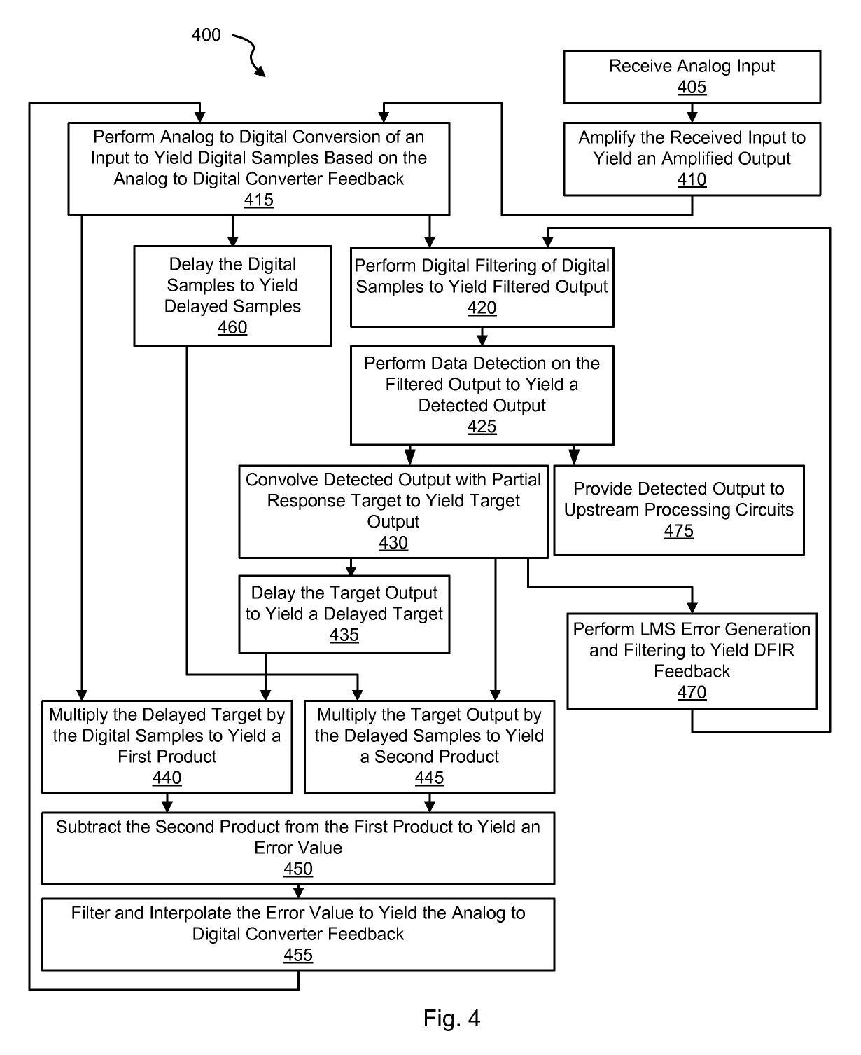

Turning to FIG. 4, a flow diagram 400 shows a method for ADC sample based timing recovery in accordance with various embodiments of the present invention. Following flow diagram 400, an analog input is received (block 405). In some cases, the analog input signal is derived from a storage medium. In other cases, the analog input signal is derived from a transmission medium. Based upon the disclosure provided herein, one of ordinary skill in the art will recognize other sources from which the analog input signal may be derived. The analog input signal is amplified to yield an amplified output (block 410). In some cases, the amplification is a variable gain amplification. In other cases, the amplification is a fixed gain amplification. Based upon the disclosure provided herein, one of ordinary skill in the art will recognize a variety of approaches for yielding the amplified output. An analog to digital conversion is performed on the amplified output to yield a series of digital samples (block 415). The digital samples are generated synchronous to a sample clock that is adjusted based upon an analog to digital converter feedback from generated from previous processing.

Digital filtering is applied to the digital data samples to yield a filtered output (block 420). In some embodiments of the present invention, the digital filtering is done by a digital finite impulse response circuit as is known in the art. A data detection process is then applied to the filtered output to yield a detected output (block 425). The detection process may be any data detection process known in the art including, but not limited to, a Viterbi algorithm detection process or a maximum a posteriori detection process. The resulting detected output is provided both as an output to an downstream processing circuit (block 475) and to a convolution filter circuit (block 430). The convolution filter circuit convolves the detected output with a partial response target to yield a target output. In some cases, the hard decision portion of the detected output is used in which case the aforementioned convolution is applied directly to the hard decision data to yield the target output. In other cases, the soft decision portion of the detected output is used. In such cases, the soft decision portion of the detected output is converted to mean values in accordance with the following equation:

$$Mean Value = \frac{exp [ Soft Decision Portion of Detected Output ] - 1}{exp [ Soft Decision Portion of Detected Output ] + 1} .$$

This conversion may be a pre-conversion where the results are stored in a lookup table for later access during processing. The mean value is convolved by the convolution circuit to yield the target output. Using the target output, a least mean squared error is generated and the error is filtered to yield a filter feedback signal that at least in part governs the operation of the digital filtering performed in block 420 (block 470).

The digital samples from block 415 are delayed by a bit period to yield delayed samples (block 460), and the target output is delayed by the bit period to yield a delayed target (block 435). The delayed target (block 435) is multiplied by the by the digital samples (block 415) to yield a first product (block 440). The target output (block 430) is multiplied by the delayed samples (block 460) to yield a second product (block 445). The second product is subtracted from the first product to yield an error value (block 450). The error value is then filtered and interpolated to yield the analog to digital converter feedback signal (block 455). In some cases, the analog to digital converter feedback signal is a sampling clock used by the analog to digital conversion process to synchronize sampling of the amplified output.

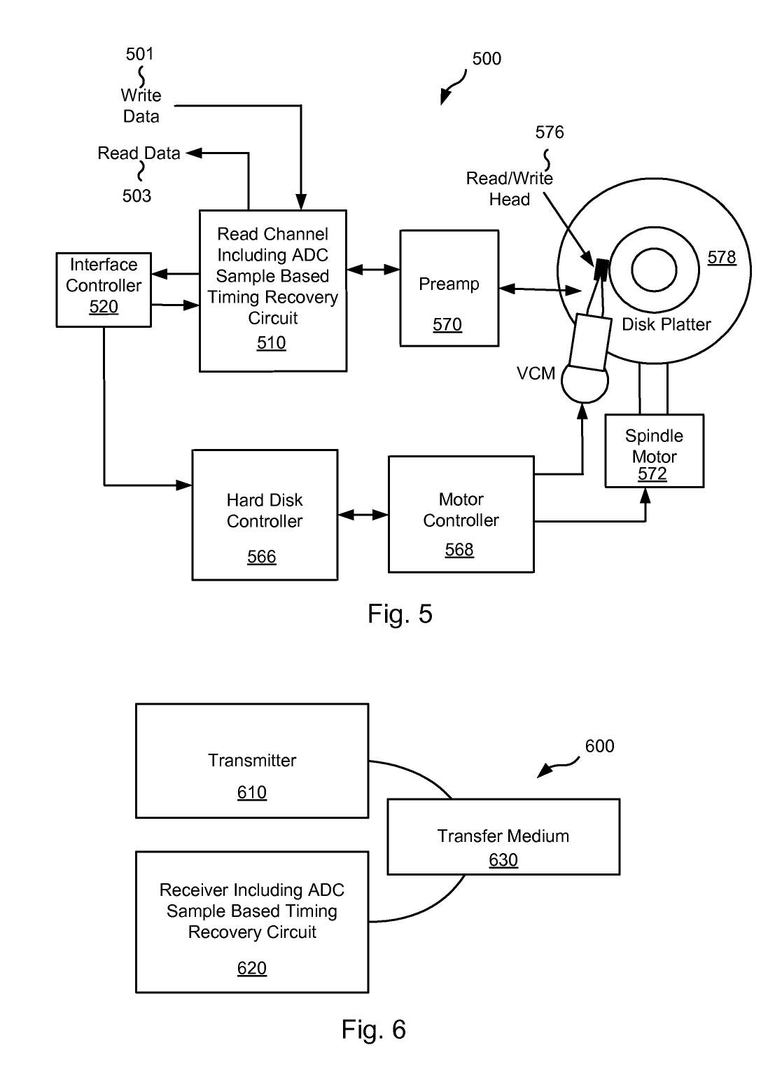

Turning to FIG. 5, a storage system 500 including a read channel circuit 510 with an ADC sample based timing recovery circuit is shown in accordance with some embodiments of the present invention. Storage system 500 may be, for example, a hard disk drive. Storage system 500 also includes a preamplifier 570, an interface controller 520, a hard disk controller 566, a motor controller 568, a spindle motor 572, a disk platter 578, and a read/write head assembly 576. Interface controller 520 controls addressing and timing of data to/from disk platter 578. The data on disk platter 578 consists of groups of magnetic signals that may be detected by read/write head assembly 576 when the assembly is properly positioned over disk platter 578. In one embodiment, disk platter 578 includes magnetic signals recorded in accordance with either a longitudinal or a perpendicular recording scheme.

In a typical read operation, read/write head assembly 576 is accurately positioned by motor controller 568 over a desired data track on disk platter 578. Motor controller 568 both positions read/write head assembly 576 in relation to disk platter 578 and drives spindle motor 572 by moving read/write head assembly to the proper data track on disk platter 578 under the direction of hard disk controller 566. Spindle motor 572 spins disk platter 578 at a determined spin rate (RPMs). Once read/write head assembly 576 is positioned adjacent the proper data track, magnetic signals representing data on disk platter 578 are sensed by read/write head assembly 576 as disk platter 578 is rotated by spindle motor 572. The sensed magnetic signals are provided as a continuous, minute analog signal representative of the magnetic data on disk platter 578. This minute analog signal is transferred from read/write head assembly 576 to read channel circuit 510 via preamplifier 570. Preamplifier 570 is operable to amplify the minute analog signals accessed from disk platter 578. In turn, read channel circuit 510 decodes and digitizes the received analog signal to recreate the information originally written to disk platter 578. This data is provided as read data 503 to a receiving circuit. As part of decoding the received information, read channel circuit 510 processes the received signal using an ADC sample based timing recovery circuit similar to those described in one or both of FIG. 2 and FIG. 3 above. In some cases, the ADC sample based timing recovery circuit may operate in accordance with the method described above in relation to FIG. 4. A write operation is substantially the opposite of the preceding read operation with write data 501 being provided to read channel circuit 510. This data is then encoded and written to disk platter 578.

It should be noted that storage system 500 may be integrated into a larger storage system such as, for example, a RAID (redundant array of inexpensive disks or redundant array of independent disks) based storage system. It should also be noted that various functions or blocks of storage system 500 may be implemented in either software or firmware, while other functions or blocks are implemented in hardware.

Turning to FIG. 6, a wireless communication system 600 including a receiver 620 with an ADC sample based timing recovery circuit is shown in accordance with various embodiments of the present invention. Communication system 600 includes a transmitter 610 that is operable to transmit encoded information via a transfer medium 630 as is known in the art. The encoded data is received from transfer medium 630 by receiver 620. Receiver 620 incorporates the ADC sample based timing recovery circuit that may be implemented similar to those described in one or both of FIG. 2 and FIG. 3 above. In some cases, the ADC sample based timing recovery circuit may operate in accordance with the method described above in relation to FIG. 4.

It should be noted that the various blocks discussed in the above application may be implemented in integrated circuits along with other functionality. Such integrated circuits may include all of the functions of a given block, system or circuit, or only a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

In conclusion, the invention provides novel systems, devices, methods and arrangements for data processing. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A data processing circuit, the data processing circuit comprising:
an analog to digital converter circuit operable to receive a data input and to provide corresponding digital samples;
a digital filter circuit operable to receive the digital samples and to provide a filtered output;
a data detector circuit operable to perform a data detection process on the filtered output to yield a detected output; and
a phase detector circuit operable to calculate an error feedback value based at least in part on the detected output and the digital samples.

2. The data processing circuit of claim 1, wherein a sampling of the data input by the analog to digital converter circuit is governed at least in part by a sampling clock derived from the error feedback value.

3. The data processing circuit of claim 1, wherein the phase detector circuit includes:
a first multiplier circuit connected to the digital samples and a first derivative of the detected output, and operable to multiply the digital samples by the first derivative of the detected output to yield a first product;
a second multiplier circuit connected to a delayed version of the digital samples and a second derivative of the detected output, and operable to multiply delayed version of the digital samples by the second derivative of the detected output to yield a second product; and
a summation circuit operable to subtract the second product from the first product to yield the error feedback value.

4. The data processing circuit of claim 3, wherein the data processing circuit further comprises:
a convolution circuit operable to convolve the detected output with a target to yield a target output; and
wherein the second derivative of the detected output is the target output, and wherein the first derivative of the detected output is a delayed version of the target output.

5. The data processing circuit of claim 3, wherein the detected output includes hard decision data.

6. The data processing circuit of claim 3, wherein the data processing circuit further comprises:
a soft decision conversion circuit operable to convert the detected output into a hard output;
a convolution circuit operable to convolve the hard output with a target to yield a target output; and
wherein the second derivative of the detected output is the target output, and wherein the first derivative of the detected output is a delayed version of the target output.

7. The data processing circuit of claim 6, wherein the detected output includes soft decision data.

8. The data processing circuit of claim 7, wherein the hard output is a mean of the soft decision data.

9. The data processing circuit of claim 8, wherein the mean of the soft decision data is calculated in accordance with the following equation:
$$Mean of the Soft Decision Data = \frac{exp [ Soft Decision Data ] - 1}{exp [ Soft Decision Data ] + 1} .$$

10. The data processing circuit of claim 6, wherein the soft decision conversion circuit includes a lookup table.

11. The data processing circuit of claim 1, wherein the data processing circuit is implemented in an integrated circuit.

12. The data processing circuit of claim 1, wherein the data processing circuit is implemented as part of an electronic device selected from a group consisting of: a storage device and a transmission device.

13. A method for timing recovery in a data processing circuit, the method comprising:
receiving a data input;
converting the data input into digital samples synchronous to a sampling clock;
filtering the digital samples to yield a filtered output;
performing a data detection on the filtered output to yield a detected output;
multiplying the digital samples by a first derivative of the detected output to yield a first product;
multiplying a delayed version of the digital samples by a second derivative of the detected output to yield a second product;
subtracting the second product from the first product to yield an error feedback value; and
adjusting the sampling clock based at least in part on the error feedback value.

14. The method of claim 13, wherein the method further comprises:
convolving the detected output with a target to yield a target output, wherein the first derivative of the detected output is a delayed version of the target output, and wherein the second derivative of the detected output is the target output.

15. The method of claim 13, wherein the method further comprises:
converting a soft decision portion of the detected output into a hard output; and
convolving the hard output with a target to yield a target output, wherein the first derivative of the detected output is a delayed version of the target output, and wherein the second derivative of the detected output is the target output.

16. A storage device, the storage device comprising:
a storage medium;
a head assembly disposed in relation to the storage medium and operable to derive a data input from the storage medium;
an analog to digital converter circuit operable to convert the data input to a series of digital samples synchronous to a sampling clock;
a digital filter circuit operable to receive the digital samples and to provide a filtered output;
a data detector circuit operable to perform a data detection process on the filtered output to yield a detected output; and
a phase detector circuit operable to calculate an error feedback value based at least in part on the detected output and the digital samples, wherein a phase of the sampling clock corresponds to the error feedback value.

17. The storage device of claim 16, wherein the phase detector circuit includes:
a first multiplier circuit connected to the digital samples and a first derivative of the detected output, and operable to multiply the digital samples by the first derivative of the detected output to yield a first product;
a second multiplier circuit connected to a delayed version of the digital samples and a second derivative of the detected output, and operable to multiply delayed version of the digital samples by the second derivative of the detected output to yield a second product; and
a summation circuit operable to subtract the second product from the first product to yield the error feedback value.

18. The storage device of claim 17, wherein the storage device further comprises:
a convolution circuit operable to convolve the detected output with a target to yield a target output; and
wherein the second derivative of the detected output is the target output, and wherein the first derivative of the detected output is a delayed version of the target output.

19. The storage device of claim 17, wherein the storage device further comprises:
a soft decision conversion circuit operable to convert the detected output into a hard output;
a convolution circuit operable to convolve the hard output with a target to yield a target output; and
wherein the second derivative of the detected output is the target output, and wherein the first derivative of the detected output is a delayed version of the target output.

20. The storage device of claim 19, wherein the detected output includes soft decision data, and wherein the hard output is a mean of the soft decision data.
